(19) United States
(12) Patent Application Publication
(10) Pub. No.: US 2004/0031128 A1
(43) Pub. Date: Feb. 19, 2004

(54) Handle grip structure

(76) Inventor: Sheng-Jen Chen, San-Chung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/216,956

(22) Filed: Aug. 13, 2002

(51) Int. Cl. B62B 1/00

(52) U.S. Cl. 16/436

(57) ABSTRACT

A handle grip structure includes an elastic tube, and an impregnated polyurethane layer mounted on an outer periphery of the elastic tube by a predetermined working process, so that the polyurethane layer are integrally formed on the elastic tube, thereby forming an integral structure Thus, the handle grip structure may have an excellent shock absorbing effect, thereby efficiently reducing the vibration when hitting the ball, and thereby greatly decreasing the sport damage applied on the user.

### BACKGROUND OF THE INVENTION

1. Field of the Invention

The present invention relates to a handle grip structure, and more particularly to a handle grip structure that may have an excellent shock absorbing effect, thereby efficiently reducing the vibration when hitting the ball, and thereby greatly decreasing the sport damage applied on the user.

2. Description of the Related Art

A conventional handle grip includes a rubber tube, and an artificial leather wound around the rubber tube. However, the artificial leather is wound around the rubber tube in a manual manner, thereby consuming much working time and thereby increasing the cost of fabrication. In addition, the artificial leather has a poor shock absorbing effect, thereby easily causing a sport damage to the user.

The closest prior art references of which the applicant is aware are disclosed in the Taiwanese Patent Publication No. 225676; 246845; 248690; 289265; 300457; 314798; 334808; 337182; 339681; 3512205; and 364378. Each of the above-mentioned prior art references disclosed a handle grip made of a weaving layer or a felt layer. However, the weaving layer or felt layer has a poor elastic restoring force, so that the shock absorbing effect of the conventional handle grip is limited.

The closest prior art references of which the applicant is aware are disclosed in the U.S. Patent No. 5,571,050; 5,571,051; 5,584,482; 5,618,041; 5,645,501; 5,671,923; 5,695,418; 5,730,669; 5,772,524; 5,785,607; 5,797,813; 5,803,828; 5,813,921; 5,816,933; 5,827,129; 5,816,934; 5,857,929; 5,890,972; 5,895,329; 5,910,054; 5,997,421; and 6,203,308. Each of the above-mentioned prior art references disclosed a handle grip.

### SUMMARY OF THE INVENTION

The present invention has arisen to mitigate and/or obviate the disadvantage of the conventional handle grip.

The primary objective of the present invention is to provide a handle grip structure that may have an excellent shock absorbing effect, thereby efficiently reducing the vibration when hitting the ball, and thereby greatly decreasing the sport damage applied on the user.

In accordance with the present invention, there is provided a handle grip structure, comprising:

an elastic tube; and

an impregnated polyurethane layer mounted on an outer periphery of the elastic tube by a predetermined working process, so that the polyurethane layer are integrally formed on the elastic tube, thereby forming an integral structure.

The handle grip structure further comprises a foamed layer mounted between the polyurethane layer and the elastic tube. Preferably, the foamed layer is mounted on the outer periphery of the elastic tube in a bonding, wrapping or winding manner.

Further benefits and advantages of the present invention will become apparent after a careful reading of the detailed description with appropriate reference to the accompanying drawings.

### BRIEF DESCRIPTION OF THE DRAWINGS

FIG. 1 is a side plan cross-sectional view of a handle grip structure in accordance with a first embodiment of the present invention;

FIG. 1A is a partially enlarged view of the handle grip structure as shown in FIG. 1;

FIG. 1B is a partially enlarged view of the handle grip structure as shown in FIG. 1;

FIG. 2 is a front plan view of the handle grip structure in accordance with the first embodiment of the present invention;

FIG. 3 is a side plan cross-sectional view of a handle grip structure in accordance with a second embodiment of the present invention;

FIG. 3A is a partially enlarged view of the handle grip structure as shown in FIG. 3; and

FIG. 3B is a partially enlarged view of the handle grip structure as shown in FIG. 3.

### DETAILED DESCRIPTION OF THE INVENTION

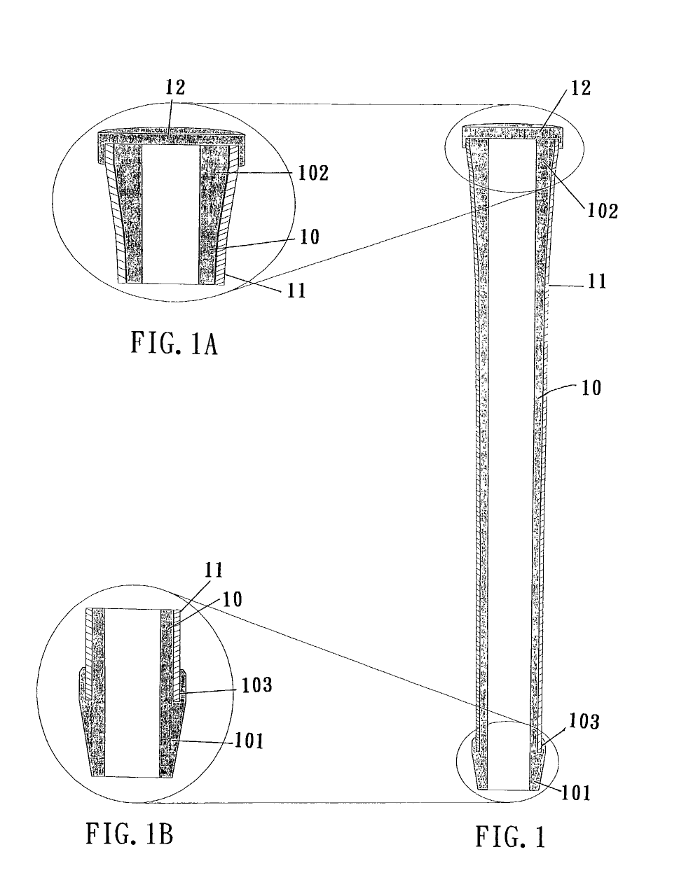

Referring to the drawings and initially to FIGS. 1, 1A and 1B, a handle grip structure in accordance with a first embodiment of the present invention is available for a tennis racket handle, a badminton racket handle, a golf club handle, a baseball bat or the like, and comprises an elastic tube 10. The elastic tube 10 may be made of a rubber or a foamable material. The elastic tube 10 has a head end 101 and a tail end 102. The head end 101 of the elastic tube 10 has an outer periphery formed with a groove 103.

An impregnated polyurethane (PU) layer 11, such as a PU resin, is coated on an outer periphery of the elastic tube 10, and is extended from the groove 103 of the head end 101 of the elastic tube 10 to the tail end 102 of the elastic tube 10. Then, the polyurethane layer 11 and the elastic tube 10 are placed into a solidification tank, so that the polyurethane layer 11 may be solidified initially. Then, the polyurethane layer 11 and the elastic tube 10 are placed into a heated tank, so that the polyurethane layer 11 may be solidified entirely. Then, the polyurethane layer 11 and the elastic tube 10 are processed by an extruding device to extrude the water contents. Then, the polyurethane layer 11 and the elastic tube 10 are placed into a drying equipment to be dried, so that the polyurethane layer 11 and the elastic tube 10 are integrally arranged. Then, a cover 12 is mounted on the tail end 102 of the elastic tube 10, thereby forming the handle grip structure.

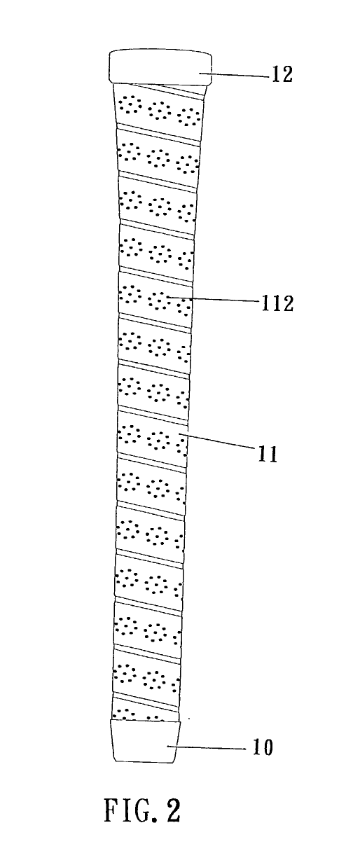

As shown in FIG. 2, after the polyurethane layer 11 is coated on the elastic tube 10, the outer periphery of the polyurethane layer 11 may be formed with a knurl 112, thereby providing an anti-skid effect, and thereby enhancing the aesthetic quality of the handle grip structure.

Thus, in the handle grip structure in accordance with the present invention, the polyurethane layer 11 is integrally formed on the elastic tube 10, without having to proceed a complicated working process of winding an artificial leather around the conventional handle grip manually, thereby saving the working time and thereby decreasing the cost of fabrication. In addition, the polyurethane layer 11 has an elastic effect greater than that of the artificial leather, so that the handle grip structure of the present invention has a better shock absorbing effect, thereby decreasing the sport damage applied on the user.

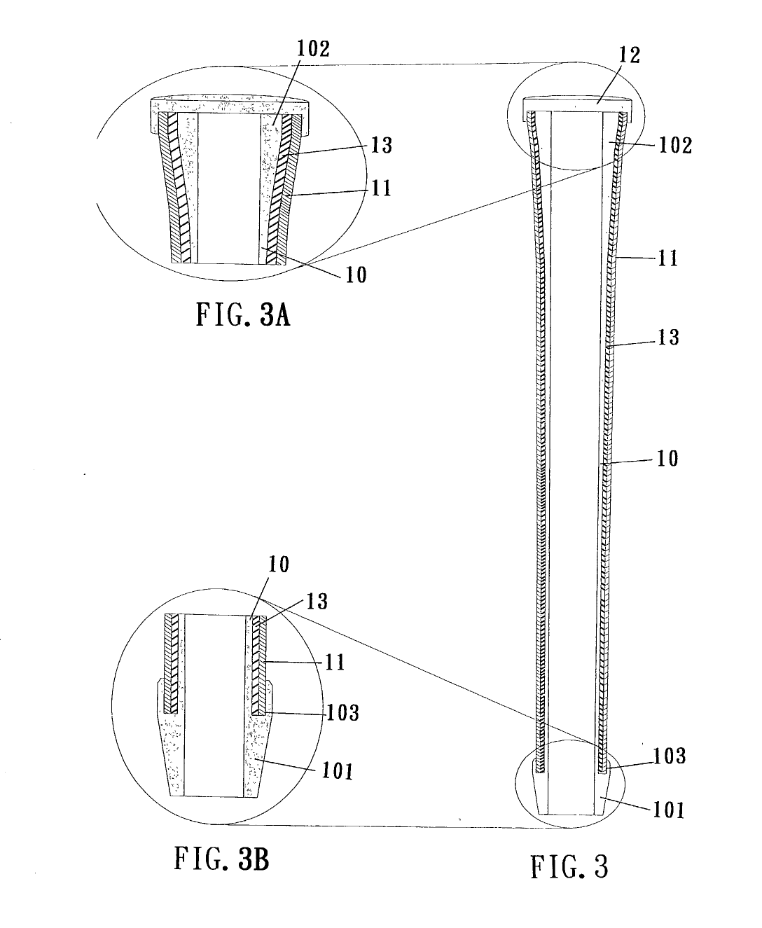

Referring to FIGS. 3, 3A and 3B, a handle grip structure in accordance with a second embodiment of the present invention further comprises a foamed layer 13 bonded, coated wound on the outer periphery of the elastic tube 10, and is extended from the groove 103 of the head end 101 of the elastic tube 10 to the tail end 102 of the elastic tube 10. Then, an impregnated polyurethane (PU) layer 11 is coated on an outer periphery of the foamed layer 13, and is extended from the groove 103 of the head end 101 of the elastic tube 10 to the tail end 102 of the elastic tube 10. Then, the polyurethane layer 11, the foamed layer 13 and the elastic tube 10 are placed into a solidification tank, so that the polyurethane layer 11 may be solidified initially. Then, the polyurethane layer 11, the foamed layer 13 and the elastic tube 10 are placed into a heated tank, so that the polyurethane layer 11 may be solidified entirely. Then, the polyurethane layer 11, the foamed layer 13 and the elastic tube 10 are processed by an extruding device to extrude the water contents. Then, the polyurethane layer 11, the foamed layer 13 and the elastic tube 10 are placed into a drying equipment to be dried, so that the polyurethane layer 11, the foamed layer 13 and the elastic tube 10 are integrally arranged. Then, a cover 12 is mounted on the tail end 102 of the elastic tube 10, thereby forming the handle grip structure.

Thus, by provision of the elastic foamed layer 13 between the polyurethane layer 11 and the elastic tube 10, the handle grip structure of the present invention may have an excellent shock absorbing effect, thereby efficiently reducing the vibration when hitting the ball, and thereby greatly decreasing the sport damage applied on the user.

While the preferred embodiment of the present invention has been shown and described, it will be apparent to those skilled in the art that various modifications may be made in the embodiment without departing from the spirit of the present invention. Such modifications are all within the scope of the present invention.

What is claimed is:

1. A handle grip structure, comprising:
an elastic tube; and
an impregnated polyurethane layer mounted on an outer periphery of the elastic tube by a predetermined working process, so that the polyurethane layer are integrally formed on the elastic tube, thereby forming an integral structure.

2. The handle grip structure in accordance with claim 1, wherein the elastic tube may be made of a rubber or a foamable material.

3. The handle grip structure in accordance with claim 1, wherein the polyurethane layer is a PU resin.

4. The handle grip structure in accordance with claim 1, further comprising a foamed layer mounted between the polyurethane layer and the elastic tube.

5. The handle grip structure in accordance with claim 4, wherein the foamed layer is mounted on the outer periphery of the elastic tube in a bonding, wrapping or winding manner.

6. The handle grip structure in accordance with claim 1, wherein the elastic tube has a head end and a tail end, the head end of the elastic tube has an outer periphery formed with a groove, and the polyurethane layer is extended from the groove of the head end of the elastic tube to the tail end of the elastic tube.

7. The handle grip structure in accordance with claim 6, further comprising a cover mounted on the tail end of the elastic tube.
